(19) United States
(12) Patent Application Publication
(10) Pub. No.: US 2006/0222264 A1
(43) Pub. Date: Oct. 5, 2006

(54) Method for vertically orienting a face shown in a picture

(75) Inventors: Jesus Fernando Guitarte Perez, Munchen (DE); Steffen Harengel, Munchen (DE); Carlos Lucas, Zaragoza (ES); Klaus Lukas, Munchen (DE)

Correspondence Address: LERNER GREENBERG STEMER LLP, P O BOX 2480, HOLLYWOOD, FL, 33022-2480, US

(73) Assignee: Siemens AG

(21) Appl. No.: 11/396,018

(22) Filed: Mar. 31, 2006

(30) Foreign Application Priority Data
Mar. 31, 2005 (DE) 10 2005 014 773.9

(51) Int. Cl. G06K 9/32

(52) U.S. Cl. 382/296

(57) ABSTRACT

What has become a widespread function in mobile or stationary communication terminals is taking pictures using cameras integrated in the mobile communication terminals. The pictures are taken sideways or upright depending on the specific situation, but other orientations also occur. Once taken, the pictures can be displayed directly on small screens or used by further applications. If slanted pictures have been taken a user will have to turn the mobile communication terminal to be able to view the face in its correct position. Moreover, face animations using pictures that have been taken are extremely difficult if the faces shown in the pictures are not in vertically oriented positions. To resolve this problem a method determines an optimized orientation of the picture by applying a face-localizing method.

### BACKGROUND OF THE INVENTION

### Field of the Invention

The present invention relates to a method and a computer-program product for vertically orienting a face shown in a picture.

What has become a widespread function in mobile or stationary communication terminals is taking pictures using cameras integrated in the mobile communication terminals. The pictures are taken sideways or upright depending on the specific situation, but other orientations also occur. Once taken, the pictures can be displayed directly on small screens or used by further applications.

One such application for mobile or stationary communication terminals is to show a picture of an incoming caller, in particular a portrait, on the operating display of the communication terminal. Besides a picture of the caller, the name of the caller and telephone number are usually also displayed. These are termed “calling faces” and broaden the multimedia character of communication terminals in an especially user-friendly manner since they allow a user to tell at first glance who is calling. Moreover, further personalizing of communication terminals is achieved by the function, a factor regarded in the communications sector as being a key to success.

A further interesting application for mobile or stationary communication terminals is what is termed “SMS reading”, wherein a text message is read aloud by a speech-synthesis system as an accompaniment to a display of a face-animated picture of the author of the text message.

A disadvantage of the above-described methods is that if pictures have been taken slanted a user will have to turn the mobile communication terminal to be able to view the face in its correct position. Moreover, face animations using pictures that have been taken are extremely difficult if the faces shown in the pictures are not in vertically oriented positions.

Pictures taken slanted must at present be turned into their correct position manually, for example the picture is rotated in a presentation program in 90° steps until the user has found the correct position. Another possibility is to provide the mobile communication terminal with an orientation sensor. The information from the orientation sensor is co-stored when a picture is taken and subsequently used to present the picture in its correct position. Being expensive, the gyroscopic sensor required for this purpose is not incorporated in mobile communication terminals.

### SUMMARY OF THE INVENTION

It is accordingly an object of the invention to provide a method for vertically orienting a face shown in a picture that overcomes the above-mentioned disadvantages of the prior art methods of this general type, by which a face shown in a picture is vertically oriented automatically.

In a method for orienting a picture showing a face, the picture is turned according to the invention in steps having specifiable rotation angles through a total of 360° around a centrally located image-area normal. A quality value of a face-localizing algorithm is in each case determined for a rotation step, which value is applied to the picture rotated through the respective rotation angle. An optimized orientation of the picture is determined using the quality values.

Face-localizing methods are functionally assignable to image-analysis methods. Without restricting the generality of the term, instances of image-analysis methods include methods for recognizing patterns or, as the case may be, detecting objects within a picture. Segmenting is customarily performed in the methods in a first step that involves assigning pixels to an object. The shape and/or form of the objects are identified in a second step by applying morphological techniques. In a third, classification step the identified objects are finally assigned to specific classes. A further typical instance of an image-analysis method is handwriting recognition.

According to an advantageous embodiment of the invention the specifiable rotation angles are in each case 90°. An advantageous effect thereof is that missing corners that would have to be additionally determined do not occur when the picture is rotated.

According to a preferred variant embodiment of the invention a mask of the face-localizing algorithm is mathematically turned via a rotation matrix through the respectively specified rotation angle. The quality value of the face-localizing algorithm applied to the picture is determined for the respective rotation angle using the turned mask. An optimized orientation of the picture is determined using the quality values, and the picture can be shown turned through the determined rotation angle. An advantageous effect thereof is that it is no longer the picture but only the mask of the face-localizing algorithm that will have to be rotated. Rotating the mask having typically 9 or 25 elements is far less computer intensive than rotating a complete picture having approximately 480,000 pixels.

A further reduction in necessary computing power and requisite storage space is achieved through reading out pixels needed for determining the quality values of the face-localizing algorithm and applying the rotated masks to the read-out pixels. The requisite pixels are thus read out only once and then used for determining the quality values by the individual masks or by one mask combining characteristics of the individual rotated masks. Further computing power can be saved by using symmetrical masks because the quality values are determined for a plurality of rotation angles when the masks are applied in one determining operation.

According to a further advantageous embodiment of the present invention an optimized orientation of the picture is determined precisely to the degree from the position of facial features, in particular the eyebrows or mouth, relative to axes of a coordinate system of the picture. An advantageous effect achieved through orienting precisely to the degree is that an opportunity to exactly orient the picture representing a face is available independently of the specifiable rotation angles. A first orienting of the picture can, for example, be followed by even more exact, precise-to-the-degree orienting performed in a further step.

According to an advantageous development of the invention, corners of the picture that are missing after it has been rotated through a non-orthogonal rotation angle are determined by way of mirroring along a picture edge of the missing picture corner. Corners of the picture will be missing when, for example, the picture is rotated through 20° and then has to be fitted into the original picture frame (see also FIG. 3). The proposed development provides a simple and fast method for filling in the missing corners.

According to further embodiments of the invention the information about the optimized orientation of the picture is stored in the picture, for example in a header of a JPEG image, or assigned to the picture so that the information will be quickly accessible as and when required. The optimally oriented picture is alternatively stored.

In the embodiment of the inventive computer-program product the picture is turned by the program-run control device for orienting a picture representing a face in steps having specifiable rotation angles through a total of 360° around a centrally located image-area normal. A quality value of a face-localizing algorithm applied to the picture rotated through the respective rotation angle is in each case determined for a rotation step. An optimized orientation of the picture is determined using the quality values.

Other features which are considered as characteristic for the invention are set forth in the appended claims.

Although the invention is illustrated and described herein as embodied in a method for vertically orienting a face shown in a picture, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is diagrammatic, illustration of a face having facial features localized by a face-localizing algorithm according to the invention;

FIGS. 2A-2D are diagrammatic, illustrations of a face in positions rotated successively counterclockwise through 90°; and

FIGS. 3A-3D are photographs of a face that has been turned, based on the facial geometry, counterclockwise through 20° and whose corners have been filled in with existing picture material.

### DESCRIPTION OF THE PREFERRED EMBODIMENTS

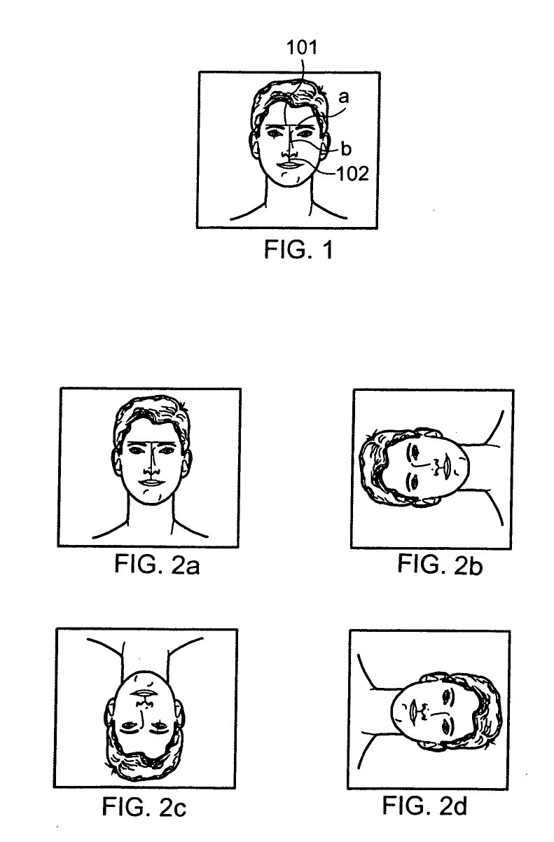

Referring now to the figures of the drawing in detail and first, particularly, to FIG. 1 thereof, there is shown a schematic of a face in which eyebrows 101 and a distance from the eyebrows 101 to a mouth 102 have been identified by a face-localizing algorithm. Given a ratio of the distance of the eyebrows from each other “a” and the distance from the eyebrows to the mouth “b” of approximately a/b=1:2, a face is recognized by the face-localizing algorithm. These geometric conditions can be recognized by the face-localizing algorithm only if the picture is correctly oriented.

A geometric method for analyzing a picture to establish the presence and position of a face contains an initial operation to determine segments of the recorded image that exhibit brightness-specific features. The features can include, for example, bright-to-dark transitions and/or dark-to-bright transitions. A check is then carried out to establish a mutual positional relationship between the segments determined, with the presence of a (human) face being deduced, in particular from a specific position within the recorded image, if a selection of segments determined exhibit a specific positional relationship. Therefore the presence of a face, in particular a human face, can be deduced by the method just described by analyzing specific areas of the recorded image, namely the segments having brightness-specific features; to be more precise by checking the positional relationship of the segments determined. Segments where the brightness-specific features exhibit sharp or, as the case may be, abrupt brightness transitions, for example from dark to bright or from bright to dark, are in particular determined in the recorded image. Sharp brightness transitions of the type can be found in, for example, a face of a person, in particular where the forehead crosses over to the eyebrows or (in the case of fair-haired people) where the forehead crosses over to the shade of the eye sockets. Sharp brightness transitions of this type can, however, also be found where the area of the top lip or, as the case may be, the lip area crosses over to the mouth opening or from the mouth opening to the lip area of the bottom lip or, as the case may be, to the area of the top lip. A further brightness transition appears between the bottom lip and the chin area, to be more precise in the form of a shaded area (depending on the specific light conditions or, as the case may be, the angle of incidence of the light), based on a slight bulging of the bottom lip. Sharp brightness transitions such as those at the eyebrows, eyes, or mouth can be specially emphasized and rendered visible as a result of image preprocessing by a gradient filter.

To check the positional relationship of the determined segments, each of the segments determined is examined, for example, in a first examination step to establish whether a segment requiring to be examined is associated with a second determined segment located on a horizontal line or, as the case may be, a substantially horizontal line to the determined segment being examined. Proceeding from a recorded image defined by a plurality of pixels, the second segment does not necessarily have to be located on a horizontal line of pixels included in the segment requiring to be examined; it can also be higher or lower relative to the horizontal line by a pre-specified small amount of pixels. If a second determined horizontal segment is found, then a search will be made for a third determined segment located below the examined and second determined segment and to which it is applicable that a distance from the examined to the second determined segment and a distance from a line linking the examined and second determined segment to the third determined segment exhibits a first predefined ratio. In particular a normal line to the line linking the examined and second determined segment can be defined, with the distance from the third segment (along the normal line) to the line linking the examined and second determined segment being included in the first predefined ratio. The presence of a face can thus be deduced by the first examination step just described by determining the positional relationship between three determined segments. It is assumed herein that the examined and second determined segment each show a section of an eyebrow usually exhibiting a clearly-defined or, as the case may be, sharp bright-to-dark brightness transition from top to bottom and thus being readily recognizable. The third determined segment is a segment of a mouth or, as the case may be, the boundary area forming shadow between the top and bottom lip. Besides the possibility of using eyebrows as clearly-defined segments having brightness-specific features it is also possible to use shadow-forming areas of the eye sockets or, as the case may be, the eyes themselves or the iris itself instead of the eyebrows. The method can be flexibly extended to include additional segments requiring to be examined including, for example, recognizing spectacles or additional verifying features (nose, opened mouth).

According to a first exemplary embodiment a face-localizing algorithm is applied in each case to a picture rotated counterclockwise through 90°. FIGS. 2A-2D are pictures showing in schematic form a face. FIG. 2A showing a vertically oriented face and FIGS. 2B-2D showing the pictures of the face rotated counterclockwise successively through 90°. When the face-localizing algorithm has been applied to all the pictures shown in FIGS. 2A-2D, the picture in FIG. 2A will be accorded the highest quality value and will thus be recognized as the picture with the vertical orientation of the face shown.

It is within the discretion of a person skilled in the art to terminate the method after the face-localizing algorithm has been applied to the picture shown in FIG. 2A since the correct picture will then already have been determined. This can be established by way of, for example, an empirically determined threshold for the quality value on the exceeding of which a correct orientation of the picture will be deemed to have been secured.

The information about the correct orientation of the picture can then be stored as additional picture information in, for instance, a JPEG header of the picture. The information can also be stored as assignable information separately from the picture. It is also possible to store the picture in its correctly oriented position.

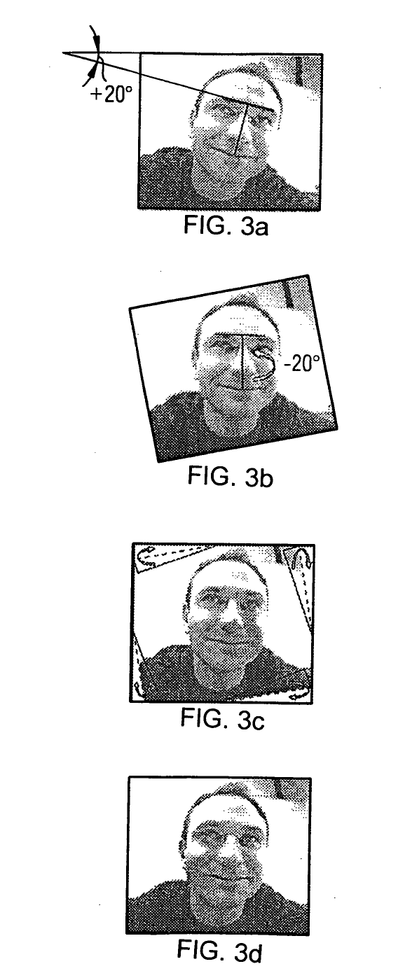

According to a further exemplary embodiment, after the face shown in a picture has been vertically oriented as in FIG. 2A the pictured face is additionally oriented precisely to the degree. FIGS. 3A-3D are photographs of a face that has been turned, based on the facial geometry, counterclockwise through 20° into the face's precise-to-the-degree vertical position and whose consequently missing corners have been filled in with existing picture material.

The position of facial features relative to the axes of the picture is first determined using the face-localizing algorithm. The facial features “eyebrows” recognized by the face-localizing algorithm and the distance from the eyebrows to the mouth are indicated in FIG. 3A. As shown in FIG. 3A, the position of, for example, the eyebrows relative to the top horizontal picture axis can be easily determined. FIG. 3B shows the ensuing rotating of the picture through −20° around a centrally located image-area normal in order to orient the face shown in the picture into the precise-to-the-degree vertical position. As shown in FIG. 3C, the consequently missing corners of the picture are filled in by the picture areas mirrored along the picture-edge axis. The picture that is obtained on termination of the method and which has the corrected position of the photographed face is shown in FIG. 3D.

The application of the present invention is not restricted to the exemplary embodiments described.

This application claims the priority, under 35 U.S.C. § 119, of German patent application No. 10 2005 014 773.9, filed Mar. 31, 2005; the entire disclosure of the prior application is herewith incorporated by reference.

We claim:

1. A method for orienting a picture showing a face, which comprises the steps of:
rotating the picture in steps having specifiable rotation angles through a total of 360° around a centrally located image-area normal;
determining a quality value of a face-localizing algorithm for each of the steps of rotation, and the quality value being applied to the picture rotated through a respectively specified rotation angle; and
determining an optimized orientation of the picture using quality values.

2. The method according to claim 1, which further comprises setting the specifiable rotation angles to be 90° each.

3. The method according to claim 1, which further comprises:
mathematically rotating a mask of the face-localizing algorithm via a rotation matrix through the respectively specified rotation angle;
determining the quality value of the face-localizing algorithm applied to the picture for the respectively specified rotation angle using a rotated mask; and
determining the optimized orientation of the picture using the quality values, and the picture can be shown turned through a determined rotation angle.

4. The method according to claim 3, which further comprises reading out pixels needed for determining the quality values of the face-localizing algorithm once and rotated masks are applied to the read-out pixels.

5. The method according to claim 1, which further comprises terminating the method when the optimized orientation of the picture has been determined.

6. The method according to claim 5, which further comprises determining the optimized orientation of the picture precisely to a degree from a position of facial features, relative to axes of a coordinate system of the picture.

7. The method according to claim 1, which further comprises determining corners of the picture that are missing after the picture has been rotated through a non-orthogonal rotation angle by way of mirroring along a picture edge of a missing picture corner.

8. The method according to claim 1, which further comprises storing information about the optimized orientation of the picture.

9. The method according to claim 1, which further comprises assign information about the optimized orientation of the picture to the picture.

10. The method according to claim 1, which further comprises storing an optimally oriented picture.

11. The method according to claim 6, which further comprises evaluating eyebrows and a mouth as the facial features.

12. A computer readable media having computer executable instructions for loading into a main memory of a program-run control device, the computer executable instructions having at least one code section for orienting a picture showing a face, the computer readable media performing a method which comprises the steps of:
rotating the picture in steps having specifiable rotation angles through a total of 360° around a centrally located image-area normal;
determining a quality value of a face-localizing algorithm for each of the steps of rotation, the quality value being applied to the picture rotated through a respective rotation angle; and
determining an optimized orientation of the picture using quality values.
